(19) United States
(12) Patent Application Publication
(10) Pub. No.: US 2005/0060350 A1
(43) Pub. Date: Mar. 17, 2005

(54) System and method for recommendation of media segments

(76) Inventors: Zachariah Journey Baum, San Francisco, CA (US); Aaron Wolf Baum, San Francisco, CA (US)

Correspondence Address: Aaron Wolf Baum, 960 Natoma Street #3, San Francisco, CA, 94103, US

(21) Appl. No.: 10/662,230

(22) Filed: Sep. 15, 2003

(51) Int. Cl. G06F 17/00

(52) U.S. Cl. 707/104.1

(57) ABSTRACT

A system and method of providing media recommendations and media segments based on expert choice lists is disclosed. Expert choice lists consisting of media segment references are retrieved through a data network and stored cumulatively in a database as records with text descriptor fields. Users of the suggestion system make requests in the form of text search descriptors and a desired output descriptor type. Descriptors of the output type in the expert choice list database are scored by the frequency with which they appear in expert choice lists possessing matches to the search descriptors. A list of the top-scoring descriptors is returned. In an alternate preferred embodiment, media segment references are scored by the frequency of their appearance in lists with matches to the search descriptors. The highest-scoring segment references are used to generate a playlist so that the recommended media segments can be presented to the user automatically.

### CROSS-REFERENCE TO RELATED APPLICATIONS

Not applicable.

### STATEMENT REGARDING FEDERALLY SPONSORED R & D

Not applicable.

The two CD-ROMs included with this application are identical and contain the following files:

| | | |
|---|---|---|
| html_scraper.pl | 3880 bytes | 3/13/2003 |
| PlayList.pm | 1273 bytes | 6/5/2002 |
| prmskopb.pl | 776 bytes | 6/5/2002 |
| vexicon.cgi | 29101 bytes | 6/5/2002 |

html_scraper.pl is an HTML file, readable by any web browser such as Internet Explorer or Netscape Navigator. All three other files are plain text.

### BACKGROUND OF THE INVENTION

This invention relates to the automatic recommendation and serving of media segments to online users.

The business of distributing audio and video segments online requires presenting, on an individual basis, the most appealing media or media suggestions quickly and consistently. The most common approaches to anticipating individual customer's tastes online involve correlating information about a user with that of other users or consumers whose preferences are known. This approach, known as collaborative filtering, is used mainly by online sites for providing individualized advertising and product/service suggestions (e.g. LikeMinds, PreferenceMetrics, Affinicast); it is also used on a research basis by organizations such as GroupLens.

However, accumulated user data is a slow and cumbersome tool for exploring the highly varied world of individual tastes in media content. A central problem for the collaborative filtering of media content is that few people have experienced much of the breadth of available content, even in the categories that they may prefer. As a result most users are poor judges of media quality, as they may have missed the best material. This problem is not reduced by using preference data from larger numbers of users; instead the mass of inexperienced users tends to drown out potentially higher quality judgments by more experienced users. Some collaborative filtering approaches attempt to identify users with broader experience, or more “trusted” givers of opinions and ratings, e.g. Epinions.com and LikeMinds. However, getting sufficient data to identify such users takes considerable time and effort, during which the system does not have their benefit. In general the collaborative filtering approach is least able to provide useful suggestions when it has limited user data, which is also when it is most in need of user's opinions. This is true when such a system is starting out or trying to extend into new media types or genres, when the system will make poor suggestions at first, discouraging users from providing the preference data critical to the collaborative filtering approach. Furthermore, typical users are generally unaware of newly available media segments, so collaborative filtering is a poor guide to emerging artists and new genres. Finally, asking users to express large numbers of preferences before the system can work properly presents a significant barrier to use, and may provoke concerns about the privacy of such information.

The automatic serving of recommended media segments reduces the user effort required to experience new media segments and keeps them from browsing to another site. The inconsistent quality of recommendations made by collaborative filtering systems makes the automatic serving of the recommended media segments risky, both in terms of wasted bandwidth and wasted user time. Existing collaborative filtering systems generally provide predicted ratings or suggestions, leaving the decision to download particular media segments to the user. This requires additional attention and delay before the media can be experienced, reducing the attractiveness of the site.

An optimal media recommendation system should generate its recommendations rapidly, based on as little user-entered information as possible. Furthermore, its recommendations should be of consistent quality so that the recommended media segment(s) can be served automatically with minimal action by the user and a high likelihood of acceptance.

In traditional broadcast media, this problem is dealt with by professional media selectors (DJs, VJs, television network programmers, etc.) who know the available media and have experience with user response. The value of experienced media selectors is evidenced by the growth of such professions. The choosing and ordering of media segments is distinct from the mixing, synchronization, or blending of media segments, which can be automated relatively easily. There are many software and hardware approaches for providing automatic mixing and sequencing of media—automatic DJ programs, etc., but these do not attempt automatic prediction of user tastes, so they are not useful as a replacement for human media experts.

The choices and recommendations made by media expert often appear as online lists or groupings associating multiple media segments—e.g. DJ & VJ playlists, reading lists, etc. These lists represent potentially high-quality suggestions, but finding, collating, and cross-referencing them presents a considerable challenge to their use in media recommendation which is not addressed in the prior art.

### BRIEF SUMMARY OF THE INVENTION

In accordance with the present invention a recommendation-generating system comprises means for automatically storing and collating expert media choices, and means for determining the expert choice media segments most relevant to user input descriptors. A method is also presented to show how to reach these goals. As an additional, optional feature, the suggested media segments can be served to the user automatically.

All references to media segments in this document should be understood to mean segments of audio or video, 3D animation, stories, books, songs, performances, movies, music videos, or other pieces of content that may be referenced in online lists showing an expert's recommendations.

Objects and Advantages

Several objects and advantages of the present invention are:
(a) to draw on the choices of a large number of media experts rapidly and automatically;
(b) to provide quality suggestions based on minimal user information;
(c) to provide quality suggestions to users exploring media types or genres in which they have expressed few or no opinions;
(d) to incorporate new media expert opinions continually, keeping the suggestions of the system current with new media and new styles;
(e) to provide quality suggestions to all users irrespective of the number of obtained user opinions;
(f) to combine obtained user opinions with expert choices to refine and individualize suggestions further;
(g) to provide media suggestions that are known to work well together, facilitating the automatic serving of multiple suggested media segments; and
(h) to minimize the storage and processing capabilities required to make quality suggestions.

Still further objects and advantages will become apparent from a consideration of the ensuing description and drawings.

### BRIEF DESCRIPTION OF THE DRAWINGS

In the drawings, closely related drawings have the same number but different alphabetic suffixes.

FIG. 1A is a schematic block diagram of a preferred embodiment of the present invention providing media segment suggestions.

FIG. 1B is a flowchart illustration of the operational steps of a preferred embodiment of the expert list site scanning module 4.

FIG. 1C is a flowchart illustration of the operational steps of a preferred embodiment of the suggestion generator 10.

FIG. 2A is a schematic block diagram of an alternative embodiment of the present invention providing media segment suggestions and the media segments themselves.

FIG. 2B is a flowchart illustration of the operational steps of a preferred embodiment of the suggestion generator 310.

FIG. 3A is an example print-out of the HTML of a music playlist site.

FIG. 3B is an example print-out of the appearance of the same music playlist site.

Reference Numerals in Drawings
2 expert list database
4 list scanning and storing module
6 data network
8 expert list sites
10 suggestion generator
12 user interface
14 data network
16 client PC
18 speakers
22 monitor
24 keyboard
26 expert site master list
302 media segment database
304 client PC with media player
306 playlist generator

### DETAILED DESCRIPTION OF THE INVENTION

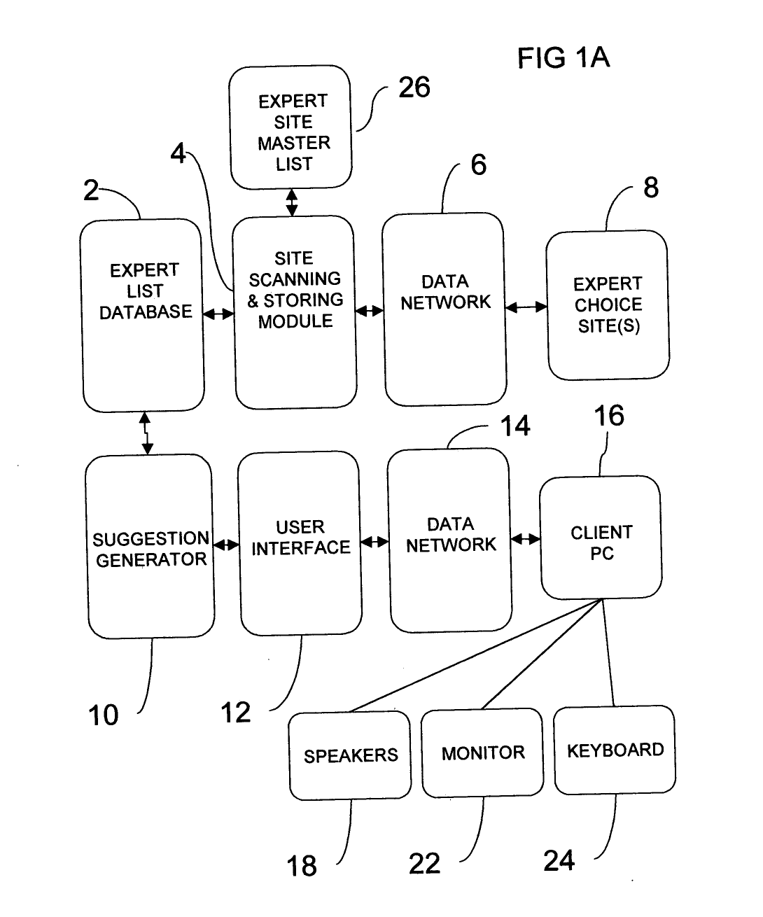

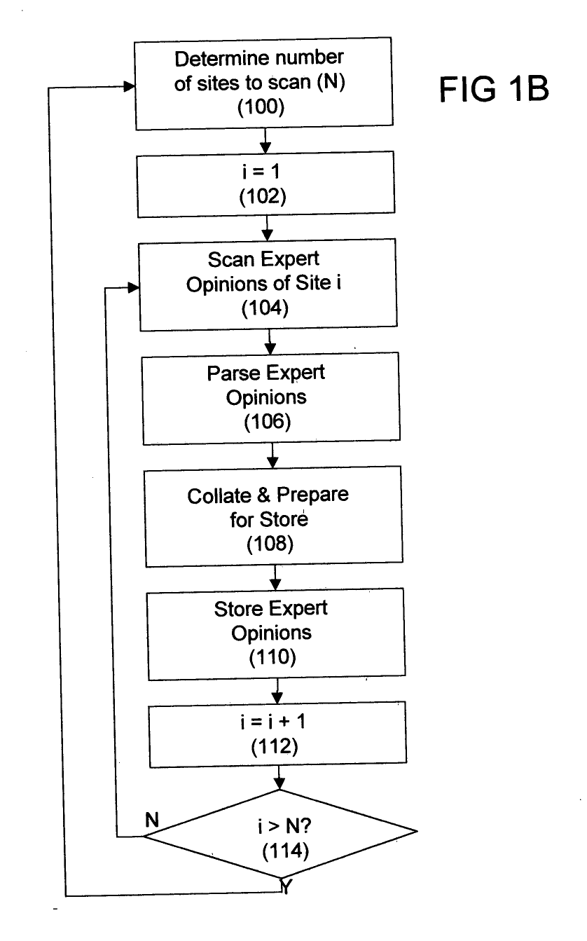

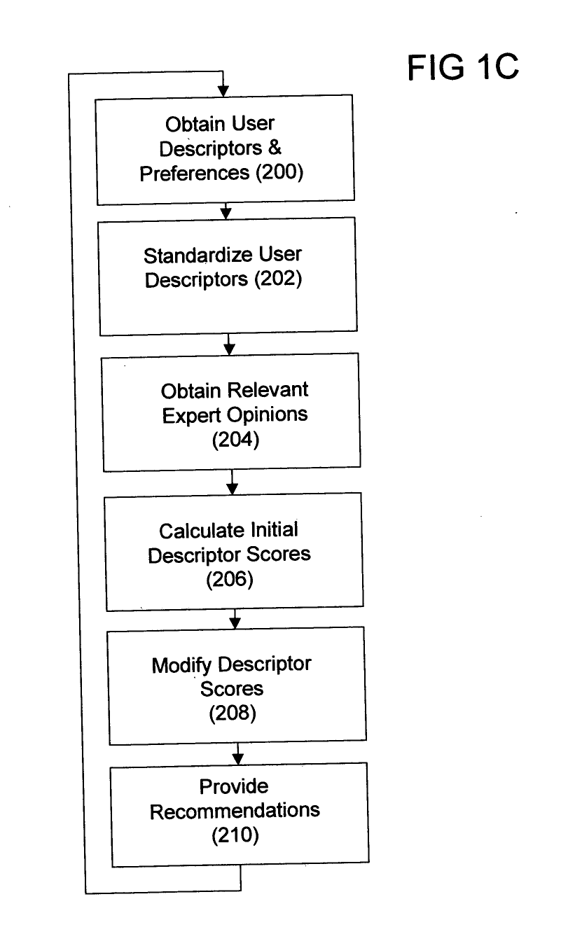

FIG. 1A

A schematic block diagram of a preferred embodiment of the media recommendation system of the present invention is illustrated in FIG. 1A. The system has a list scanning and storing module 4. Directed by an expert site master list 26, this module operates through a data network 6 to request and receive information from one or more expert choice sites 8. Module 4 stores processed data in the expert list database 2. This database is used by the suggestion generator 10 to generate media segment suggestions in response to requests received through the user interface 12. Through a data network 14, one or more users use client PCs 16 and their associated peripherals (which may include speakers 18, a video monitor 22, or a keyboard 24) to interact with user interface 12 through data network 14, requesting and receiving media segment suggestions from suggestion generator 10.

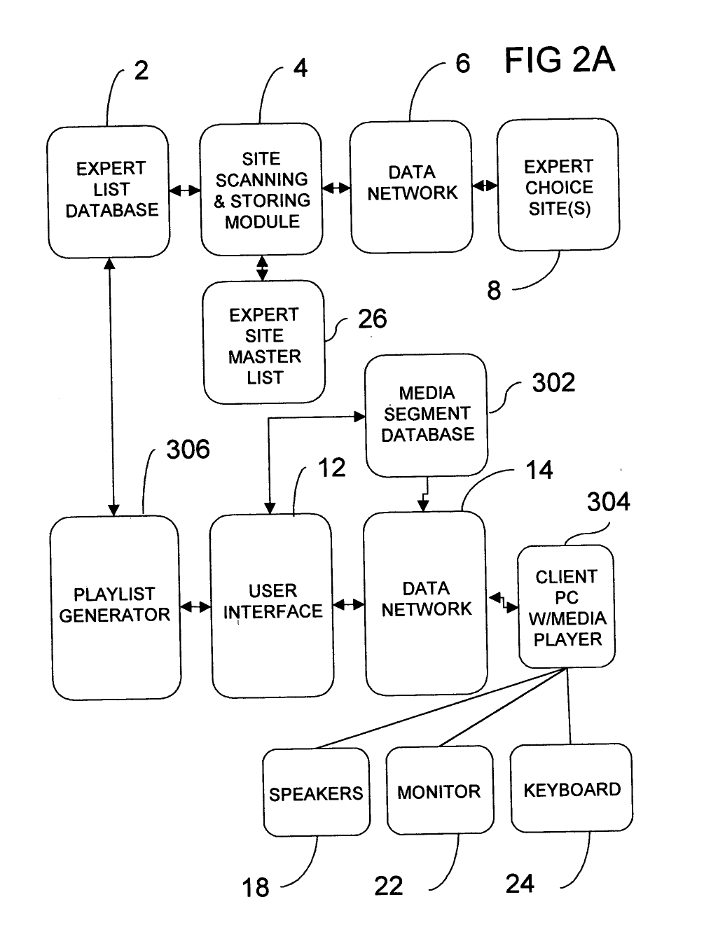

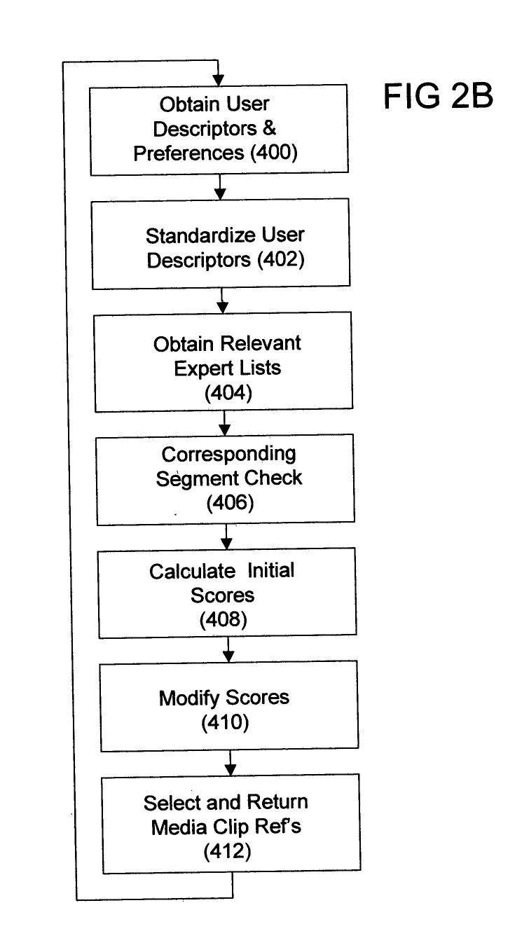

In a preferred embodiment, these parts of the system consist as follows:
1. Expert choice database 2 consists of an SQL, Oracle, mySQL, or other database program running on the same PC as list scanning and storing module 4.
2. List scanning and storing system 4 consists of Perl scripts or other computer code (C, C++, Java, etc.) running on a PC connected to data network 6.
3. Data network 6 consists of a TCP/IP network such as the Internet or a local intranet, or other type of data network such as Novell, WAP, or a proprietary type.
4. Expert choice sites 8 consist of web pages containing HTML code.
5. Suggestion generator 10 consists of Perl scripts or other computer code (C, C++, Java, etc.) running on the same PC as the list scanning and storing module 4.
6. User interface 12 consists of PHP scripts or other code generating HTML that is sent over the data network 14 to the user 16.
7. Data network 14 consists of a data network such as the Internet or a local intranet, possibly operating through TCP/IP or other protocols such as Novell, WAP, or a proprietary type. This may be the same data network as 6.
8. Client PC 16 encompasses a microprocessor, data memory, and means to access a network, such as an ethernet port, modem, or similar means, accesses the user interface through data network 14 from a web-enabled device, such as a PC, PDA, or mobile phone. Its physical user interface may include devices such as audio speakers or headphones 20, a video monitor 22, or a keyboard 24, as necessary to experience media segments and interact with user interface 12. Through data network 14 the system may interact with multiple users and their client PCs simultaneously.
9. Expert site master list 26 consists of an SQL, Oracle, mySQL, or other database program running on the same PC as list scanning and storing module 4.
   FIG. 2A—Additional Embodiment

FIG. 2A is a schematic block diagram of an alternate preferred embodiment including a media serving component. In this embodiment, two additional components are added to the schematic shown in FIG. 1A. These additional components of the system consist as follows:
1. Media database 302 consists of a storage medium containing media segments to be served in the form of individual files. These files consist of any media files playable by the PC with media player 304, preferably compressed to reduce the bandwidth required for transmission. Examples of appropriate file formats are mp3, Real Audio, Liquid Audio, Quicktime movies, and Flash animations. Media database 302 may include information about the media segments encoded by the files, such as their names, sizes, lengths, artist names, label names, compilation or album names, or genres. In a preferred embodiment, database files are served through data network 14 to client PC with media player 304 through the http protocol.
2. Client PC with media player 304 consists of a client PC similar to client PC 16, with an additional software program capable of requesting media files over data network 6 and playing them for the user. Examples of such players are WinAmp, Windows Media Player, and Quicktime. Client PC with media player 304 requests media files from media database 302. In a preferred embodiment, the requests are made through the http protocol.
3. Playlist generator 306 consists of Perl scripts or other computer code (C, C++, Java, etc.) running on the same PC as the list scanning and storing module 4. It is capable of generating a playlist consisting of file references corresponding to files of media segment database 302
   Advantages

From the description above, a number of advantages of the described expert list-based media segment suggestion system become apparent:
(a) The expert list information driving the suggestions can be drawn from an almost unlimited number of sources.
(b) The user receives the benefit of these expert lists through a single interface.
(c) No user information is required to obtain suggestions or media, allowing the service to be accessed in its entirety immediately and anonymously, without requiring registration or login.
(d) The volume of the expert list database can grow steadily to include new lists irrespective of user traffic.
(e) The suggestion generator minimizes the required bandwidth and storage to supply suggestions to users by requiring only a small amount of data to provide quality suggestions.
(f) Media segments that have been recommended by the system can be downloaded to a user's PC and played automatically.
(g) Playlists can be generated using any descriptors that can be associated with media segments in the database, including mood or genre.
   Operation Of Preferred Embodiment—FIGS. 1B-1C

Flowcharts for the operation of portions of the preferred embodiment of FIG. 1A are illustrated in FIGS. 1B-1C. FIG. 1B illustrates the operation of site scanning and storing module 4; FIG. 1C illustrates the operation of suggestion generator 10. In a preferred embodiment, the programming steps of 4 and 10 will be embodied in Perl scripts running on a personal computer connected to a data network such as the Internet. Pursuant to the Invention, these steps can be embodied in any suitable programming language, including but not limited to C, C++, Java, PHP, Javascript, or BASIC. The present invention covers these steps running on any electronic hardware that can support such programming, such as personal computers, mainframe computers, personal digital assistants, or mobile phones. In a preferred embodiment, the communication with expert list sites and users occurs over the Internet using TCP/IP and http protocols; other embodiments may include communication over local networks and other protocols over modems/intemet/wireless, such as Novell, WAP, cable networks, and proprietary systems such as set-top boxes.

Examples of computer code instantiating these steps are included in the CD-ROM associated with this specification. The files on this disk are as follows:
html_scraper.pl
A set of perl routines for parsing HTML into perl data structures.
playList.pm
A perl object representation of a play list, as returned from a filter. prmskopb.pl
A perl filter, loaded and invoked by the vexicon that uses the html_scraper routines to parse HTML from a play list site, returning a PlayList object for use in the vexicon.
vexicon.cgi
A combination of command-line play list scraper and recommendation generator CGI.

Flowcharts for a preferred embodiment of the operation of expert choice scanning and storing module 4 are illustrated in FIG. 1B.

In step 100, the module retrieves a master list of expert choice sites 26 to determine the number of sites to scan and their addresses,. In a preferred embodiment an entry on the list will consist of a URL to be accessed over the Internet, and parsing instructions for the HTML code returned from the site. The URLs to scan can be determined manually, by automatic searching over a data network such as the Internet, or by some combination of these means. For example, a search program could retrieve text and code from other sites and check it for similarities to sites already on the list. Once the master list is retrieved, the number of sites to be scanned, N, is set to the number of records in the list. The site index i is initialized to 1 (step 102) and the site scanning loop is entered (step 104).

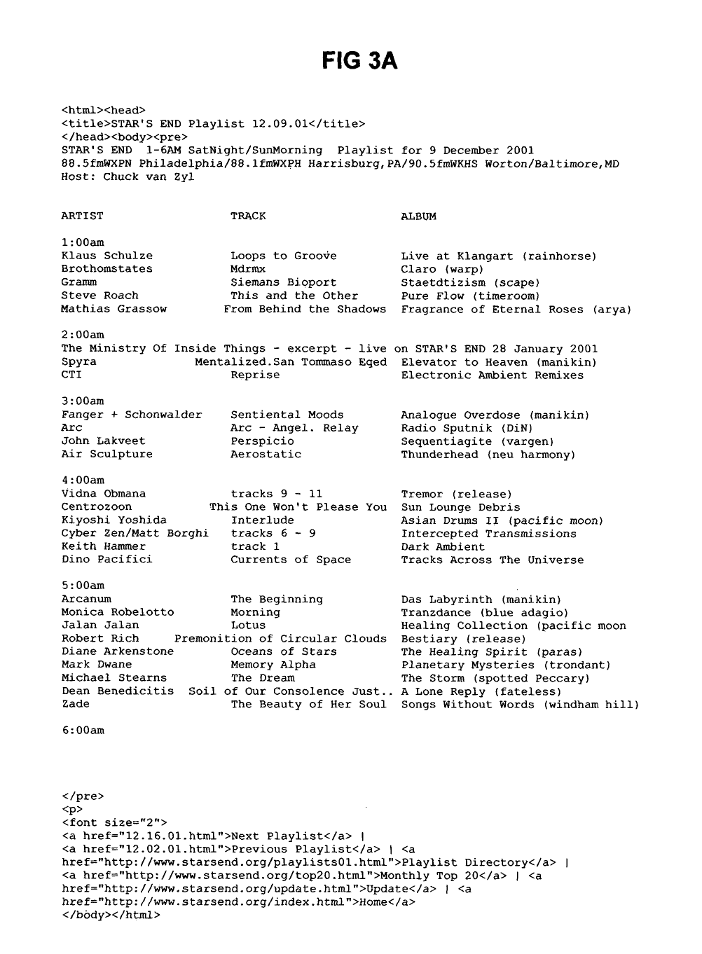

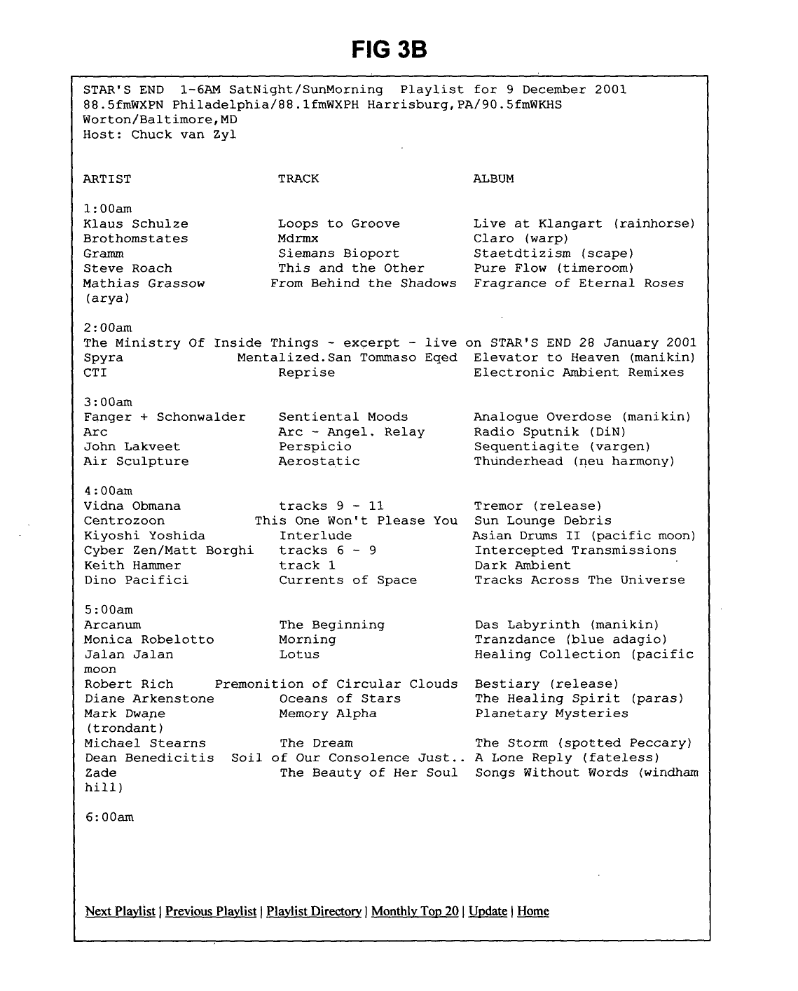

Scanning the site consists of sending requests for the expert list information from the site server. In a preferred embodiment, these requests are relayed through the intemet by the http protocol, and the site server sends HTML pages through the Internet back to the system. An example of the HTML code of a web page on an expert choice site is shown in FIG. 3A; its browser appearance is shown in FIG. 3B. A site may contain multiple pages to be retrieved; the number and addresses of these pages are stored and read from the master site list. Once all of the pages are retrieved, the raw HTML from the site is parsed into lists of individual media segment references according to site-specific instructions in step 106. In a preferred embodiment, these references are organized into a series of records with each record corresponding to an individual media segment reference on an expert choice list. The fields of these records may include the name of the list the reference was taken from, the date of that list, the name of the media expert who generated the list, the segment name, the artist name, the recording label name, the album or collection name, the director name, genre, DJ or VJ name, tempo (beats per minute), copyright date, and other pieces of information that may be available. If ordering or rating information is available from the site, this may be parsed and associated with the media segments as well.

The media segment references may then be further processed (step 108). In a preferred embodiment, any punctuation or capitalization is removed to standardize the records for later cross-referencing.

In step 110, the standardized records are stored into the expert opinion database 2 where they can be accessed by the suggestion generator 10.

A flowchart for the operation of a preferred embodiment of the suggestion generator 10 is illustrated in Fig 1C. The generator takes in search-descriptors to generate its suggestions. These can be of several different types, corresponding to the fields of the media segment records in the expert list database—artist name, expert list generator name, DJ or VJ name, genre, tempo (beats per minute), media segment name, production company name, album or collection name, copyright date, or other descriptor that could be associated with media segment references in the expert list database. In a preferred embodiment, the search descriptors are one or more artist's names. These search descriptors, and their types, are passed to the suggestion generator by the user interface. The desired output descriptor type, and the number of suggestions to return, are also obtained from the user or set automatically to default values. The descriptors may be entered directly by the user, or they may be generated by the user interface in response to user actions, such as buying a product, or experiencing a known media segment; by submitting descriptors associated with the product or segment, the suggestion generator can provide potentially related media segment suggestions. In step 202, the input descriptors are standardized by removing all punctuation and capitalization. The expert list database is then searched (step 204) for expert lists containing media segment references with one or more matches to the input descriptors in the correct fields.

In step 206, the number of times each descriptor of the specified output type is found in an expert list with any of the search descriptors is totaled. This total provides a score for ranking each descriptor of the output type. This total may be further modified (step 208) to improve its expression of the strength of the relationship between the input descriptors and the output descriptors. For example, the score of a descriptor may be modified to prevent a single web site (and thus the opinions of a small number of experts) to unduly affect a descriptor's rating. In a preferred embodiment, this is achieved by determining the number of distinct expert list web sites that a descriptor appears on, multiplying it by a weighting factor, and added the result to the descriptor's score.

The score may also be modified to emphasize lists with multiple matches. In a preferred embodiment, the contribution of each list to an output descriptor's score is weighted by the number of matches to the search descriptors within the list.

If user ratings of the media segments in the expert lists are available, the contributions to the score of each expert list can be weighted by the querying user's previous ratings of the media segments on the list. In a preferred embodiment, each expert choice list is scored by an averaging any ratings the querying user has made of media segments on the list; unrated media segments on a list can be assigned a default rating for the purposes of the calculation of the average. This average can then be used to weight the contribution of its corresponding list to the scores used to rank the output descriptors.

If search descriptors other than media segment names are specified, the suggestion generator may also calculate the most popular media segments for each of these descriptors. In a preferred embodiment, media segment names whose records match a search descriptor in the appropriate field are rated by the number of times that they appear on unique expert lists. This rating may be further modified to prevent excessive influence from single web sites by adding the number of unique web sites the segment references appear on, multiplied by a weighting factor. The highest-rating media segment references for each of the search descriptors (other than any media segment names) can then be returned as a list of associated popular media segments.

In step 210, the requested number of top scoring output descriptors and any list of associated popular media segments are returned to the user interface for display.

Operation of an Alternative Embodiment—FIG. 2B

FIG. 2A illustrates an alternative embodiment of the Invention with media streaming capabilities driven by the expert list system. FIG. 2B is a flowchart illustrating the operational steps of a preferred embodiment playlist generator 306. In a preferred embodiment, the programming steps of playlist generator 306 will be embodied in Perl scripts running on a personal computer connected to a data network such as the Internet. In pursuant to the Invention, these steps can be embodied in any suitable programming language, including but not limited to C, C++, Java, PHP, Javascript, or BASIC.

The operation of the generator starts with receiving a user request (step 400) through the user interface 12. In a preferred embodiment, the user represents the desired type of media segments by entering one or more search descriptors. These descriptors can be names of one or more artist, media segment, media label, album or collection, production company, disc or video jockey, or any other descriptors such as copyright date, play date, mood, genre, tempo range, color, or category, that can be associated with media segment references in the expert list database through the expert list scanning module. In an alternative embodiment, the search descriptors can be automatically generated by user actions such as experiencing a media segment, rating a segment, buying a product, visiting a website, or other actions which could indicate a desire for a type of music. The number of media segments to return in the play list is also passed by the user interface; this may be a fixed value or specified by the user.

In step 402, the search descriptors are standardized by removing all punctuation and capitalization. In accordance with the present invention, further processing to maximize the chances of matching with the database descriptors may be employed, such as correction of common spelling errors. In step 404, the expert list database 302 is searched for media segment references with one or more matches to the input descriptors. A list of expert lists that include at least one such matching media segment reference is returned. Each media segment reference in the returned lists is then checked for a corresponding media segment in the media segment database; references not corresponding to a segment in the database are eliminated (step 406). Each remaining media segment reference is then scored by the number of returned lists it appears on (step 408).

This score may be further modified (step 410) to maximize the accuracy of the relationship it expresses between the media segment and the input descriptors. In a preferred embodiment, the incidences of a media segment reference on the returned lists can be weighted by the relevance of the lists on which it appears; in a preferred embodiment the relevance of a list is measured by the number of matches in its record fields to the search descriptors.

If user ratings of the media segments in the expert lists are available, this information can be used to maximize the likelihood that the user will enjoy the suggested media segments. In a preferred embodiment, the contributions to the score from each expert list can be weighted by the user's previous ratings of the media segments on the list. For example, the ratings of each list can be averaged; unrated media segments on the list can be assigned a default rating for the purposes of the calculation of the average. This average can then be used to weight the contribution of its corresponding list to the scores used to rank the output descriptors. In a preferred embodiment, this weighting is applied to all contributions the corresponding list makes to the media segment scores, including the refinements described below.

The list of top-scoring media segment references can then be further refined to keep together segments which have been frequently listed together by the experts. In a preferred embodiment, the number of times a segment reference appears on an expert list with other top-scoring segments is totaled, multiplied by a weighting factor, and added to a segment reference's score from step 408. In further alternate embodiment, the contribution of each appearance with another segment reference is weighted by that segment's score as calculated in step 408. For expert lists which represent the sequential play of media segments (e.g. DJ and VJ play lists), this weighting may be increased if the other segment appears adjacent or close to the segment whose score is being calculated.

In step 412, the specified number of highest-ranking media segments are returned to the user interface 312 as a play list. The user's media player software can then send HTML requests for the media segments of the playlist through the network; the generation of these requests may be automatic or started by a user request to the media player for playback of the playlist. The user interface passes the requests to the media database, which then serves the media segments to the media player over the network. The media player then plays the media segments for the user.

Conclusion, Ramifications, and Scope

Accordingly, the reader will see that the suggestion generation system of this invention can be used to provide automatic media suggestions based on the expertise of many experts through a simple interface, to provide such suggestions with a minimum of user data entry, to provide media suggestions taking into account the most recent media segments and fashions, to minimize the bandwidth and storage required to generate media suggestions, and to serve suggested media segments automatically.

Thus the scope of the invention should be determined by the appended claims and their legal equivalents, rather than by the examples given.

1. A method for providing to a user media suggestions based on lists associating media segment references using one or more general purpose data processors, comprising:
retrieving said lists and parsing their media segment references into searchable records comprising text descriptors of corresponding media segments,
storing said records into memory available to said processor in combination with any previously stored records,
receiving a user request comprising text descriptors and specification of an output text descriptor type,
searching said stored lists and retrieving lists comprising one or more records comprising one or more text descriptors matching said user input text descriptors,
compiling a list of unique text descriptors of the output type that are present in said retrieved lists,
scoring each of said unique text descriptors of the output type according to the number of said retrieved lists it appears in, and
providing to said user a list of top-scoring text descriptors of said unique text descriptors.

2. The method of claim 1 wherein said lists associating media segment references are retrieved through a data network.

3. The method of claim 1 wherein said lists associating media segment references are HTML pages retrieved through a TCP/IP network.

4. The method of claim 1 wherein said retrieval, parsing and storage of said lists associating media segment references is automatically performed as new lists become available.

5. The method of claim 1 wherein the locations of said lists associating media segment references is stored in a master list.

6. The method of claim 5 wherein the scores of said unique text descriptors of the output type is modified by adding the number of unique locations of said master list on which said unique text descriptor has been found, multiplied by a weighting factor.

7. The method of claim 1 wherein said user requests are the descriptors of media segments just purchased or served to a user, sent automatically as a consequence of said purchasing or serving.

8. The method of claim 1 wherein media segments corresponding to said top-scoring text descriptors are automatically made available to a user.

9. A data processing system for providing to a user media suggestions based on lists associating media segment references, comprising:
(a) a general purpose data processor of known type for processing data;
(b) data storage means for storing data on a storage medium;
(c) means for retrieving said lists associating media segments and parsing them into searchable records comprising text descriptors of corresponding media segments and storing said records into said data storage with any previously stored records;
(d) means for receiving a user request comprising text descriptors and specification of an output text descriptor type;
(e) means for searching said stored lists and retrieving lists comprising one or more records comprising one or more text descriptors matching said user input text descriptors;
(f) means for compiling a list of unique text descriptors of the output type that are present in said retrieved lists
(g) means for scoring each of said unique text descriptors of the output type according to the number of said retrieved lists it appears in
(h) means for providing to said user a list of top-scoring text descriptors of said unique text descriptors

10. The data processing system of claim 9 wherein said lists associating media segment references are retrieved through a data network.

11. The data processing system of claim 9 wherein said lists associating media segment references are HTML pages retrieved through a TCP/IP network.

12. The data processing system of claim 9 wherein said retrieval, parsing and storage of said lists associating media segment references is automatically performed as new lists become available.

13. The data processing system of claim 9 wherein the locations of said lists associating media segment references is stored in a master list.

14. The data processing system of claim 13 wherein the scores of said unique text descriptors of the output type is modified by adding the number of unique locations of said master list on which said unique text descriptor has been found, multiplied by a weighting factor.

15. The data processing system of claim 9 wherein said user requests are the descriptors of media segments just purchased or served to a user, sent automatically as a consequence of said purchasing or serving.

16. The data processing system of claim 9 wherein said system includes means to store media segments and means to provide said media segments automatically to a user responsive to said list of top-scoring descriptors.
